(19) United States
(12) Patent Application Publication
(10) Pub. No.: US 2006/0095338 A1
(43) Pub. Date: May 4, 2006

(54) Strategies for gifting resources

(75) Inventor: Joseph J. Seidel, Menlo Park, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/979,566

(22) Filed: Nov. 2, 2004

(51) Int. Cl. G06Q 30/00

(52) U.S. Cl. 705/26

(57) ABSTRACT

A gifting service is described for issuing and consuming gifts via an electronic infrastructure, such as a system for distributing media resources. A giftor can interact with the electronic infrastructure to define the gift by identifying the recipient of the gift and the benefit conferred by the gift. The recipient (giftee) of the gift can be specified by identifying the telephone number of the recipient. The benefit conferred by the gift can be a monetary value that can be used like currency to purchase resources. The recipient can receive and consume the thus-defined gifts via the electronic infrastructure.

### TECHNICAL FIELD

This invention relates to strategies for gifting resources, and, in a more particular exemplary implementation, to strategies for gifting media resources among participants of a media distribution system.

### BACKGROUND

Businesses commonly allow customers to purchase paper gift certificates. Customers typically purchases gift certificates as gifts for family, friends, coworkers, and so forth. The individuals conferring the gifts are referred to as “giftors” herein, while the individuals receiving the gifts are referred to as “giftees.” In common practice, a giftor will manually transfer the paper gift certificate to a giftee, either through person-to-person exchange, by mail, or other manual means of transfer. Upon receipt of the paper gift certificate, the giftee typically visits the business which sponsors the gift certificate. If the certificate identifies specific goods or services, the giftee can redeem the certificate for those goods or services. If the certificate identifies a monetary amount, the giftee can purchase any goods or services using the gift-certificate providing that the purchases do not exceed the monetary amount of the gift certificate. If the purchases exceed the monetary amount, the giftee may opt to complement the gift certificate with conventional forms of legal tender. To facilitate this exchange, businesses may print tracking information on the certificates in the form of numbers, bar codes, and so forth. Upon redemption, the businesses will read the tracking information and perform appropriate accounting operations.

While the practice of issuing and redeeming gift certificates has enjoyed longstanding popularity, there remains room for substantial improvement to this practice. Namely, as described above, the practice of issuing and redeeming gift certificates remains a largely manual process. Businesses generate a paper certificate; giftors physically transport the certificate to the giftees; and the giftees manually carry the certificates to the store, where they are manually exchanged for goods or services. The manual steps in this practice are time-consuming and potentially onerous. These burdens may negatively impact the desirability of the gift certificates, from both the viewpoint of the giftor and the giftee.

Further, the practice of issuing and redeeming gift certificates is not well integrated with other aspects of the businesses which issue the certificates. True, the certificates may draw customers into a store to consume goods and services, but this one-time sales opportunity may not effectively establish lasting ties between the giftees and the businesses. In other words, the one-time sales opportunity may not actively engage the giftees with the businesses.

For these exemplary and non-limiting reasons, there is a need for more efficient and effective techniques for gifting resources.

### SUMMARY

According to one exemplary implementation, a method is described for gifting resources via an electronic infrastructure. The method comprises: (a) receiving instructions from a giftor to create a gift via the electronic infrastructure, wherein one instruction identifies a recipient of the gift, defining a giftee; (b) creating the gift based on the giftor's instructions; (c) transmitting the gift to the giftee via the electronic infrastructure; and (d) providing a resource to the giftee, via the electronic infrastructure, in response to the giftee using the gift.

According to another exemplary feature, the electronic infrastructure defines a system for distributing media resources to the giftor and giftee. Further, the resource provided to the giftee can also comprise a media resource (such as a movie).

According to another exemplary feature, the instruction that identifies the giftee identifies a telephone number of the giftee.

According another exemplary feature, another instruction identifies a benefit conferred by the gift. In one case, the benefit conferred is a monetary value that can be applied to purchase the resource. In another case, the benefit conferred is an entitlement to purchase a specified resource.

Additional implementations and features will be described in the following.

### BRIEF DESCRIPTION OF THE DRAWINGS

FIG. 1 shows an exemplary system for implementing a strategy for gifting resources.

FIG. 2 shows an exemplary client processing mechanism for use in the system of FIG. 1.

FIG. 3 shows exemplary head-end functionality for use in the system of FIG. 1.

FIGS. 4-7 show exemplary user interface (UI) presentations for use in the system of FIG. 1.

FIG. 8 shows an exemplary procedure associated with the creation and transmittal of a gift by a giftor.

FIG. 9 shows an exemplary procedure associated with the receipt of a gift by a giftee.

FIG. 10 shows an exemplary procedure associated with the consumption of a received gift by the giftee.

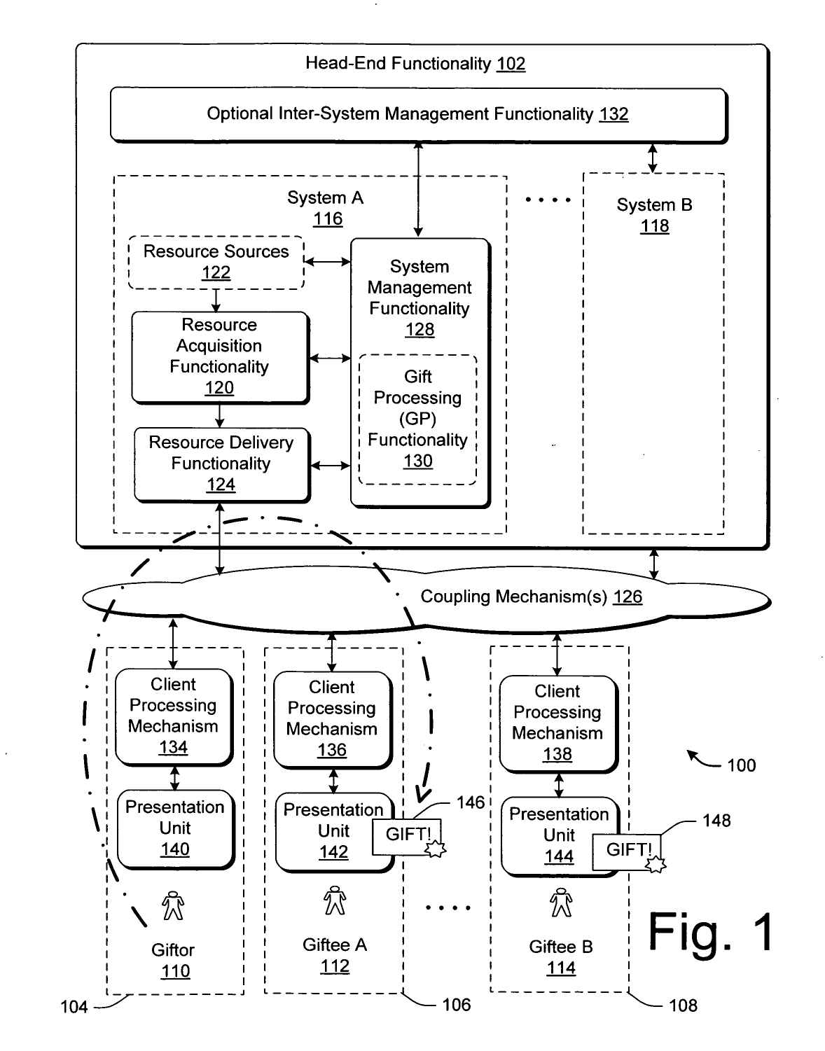

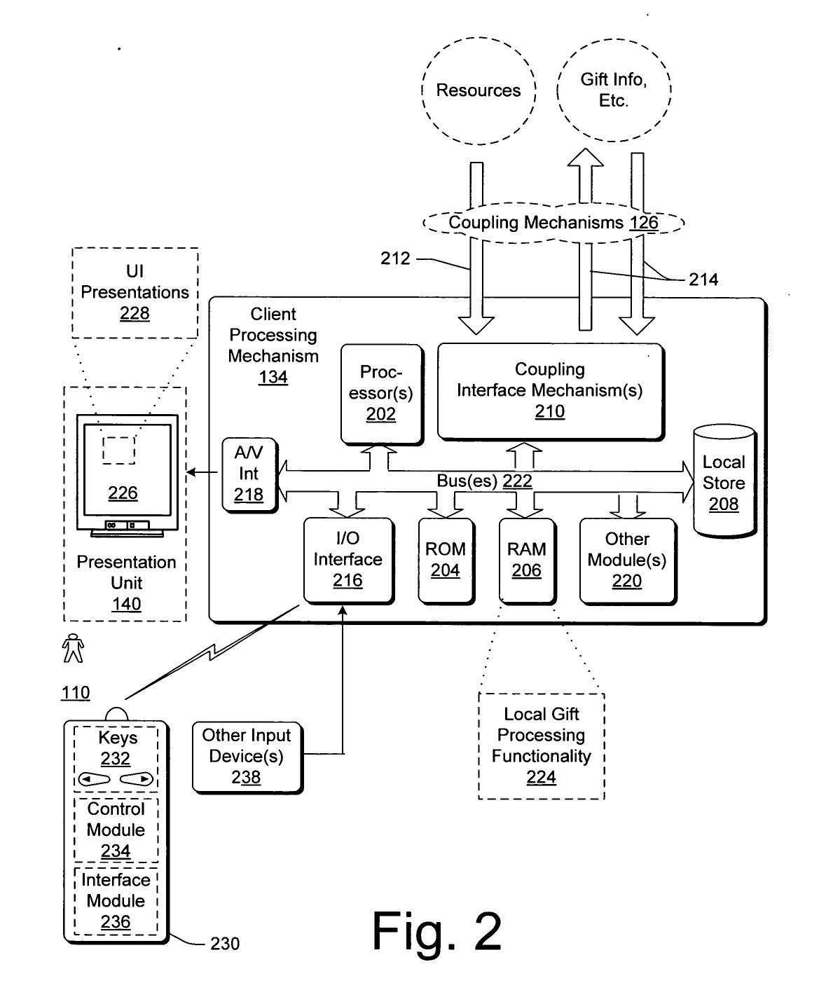

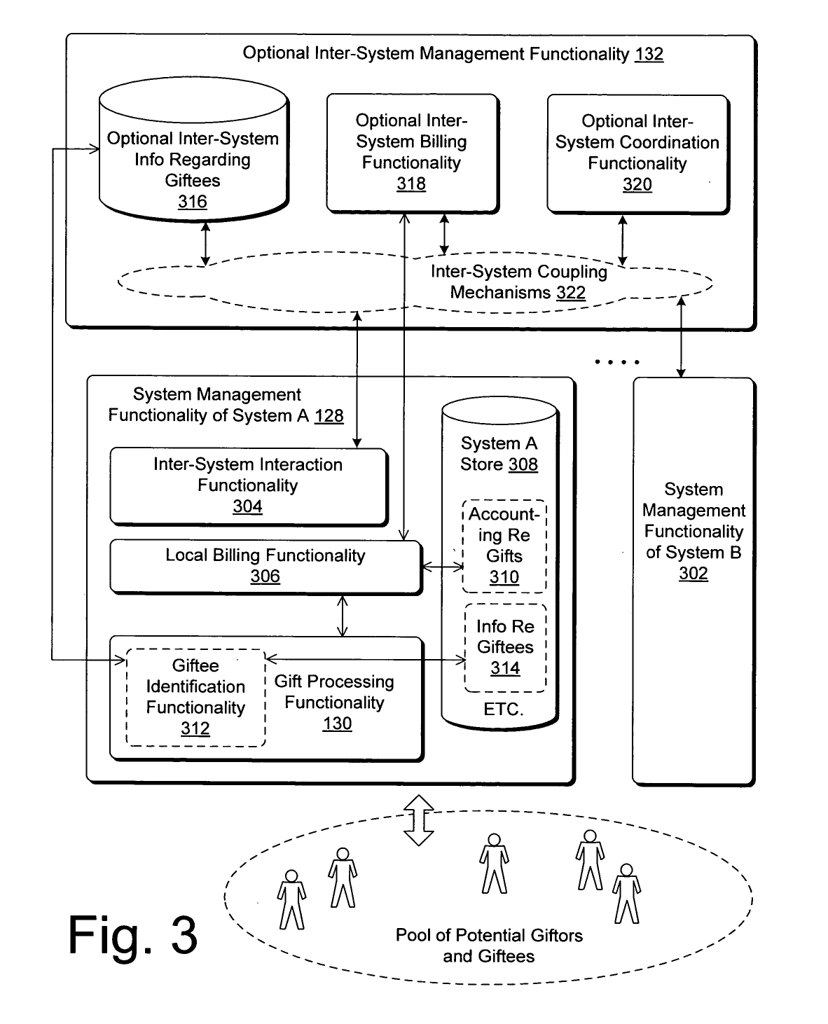

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

According to one implementation, a gifting service is described herein which allows a giftor to confer a gift to a giftee via an electronic infrastructure. Namely, a giftor can use the electronic infrastructure to create a gift by identifying the giftee and by identifying the resources that can be consumed using the gift. The giftor can identify the giftee using any kind of identification data, such as the telephone number of the giftee, the address of the giftee, and so forth. In one case, the gift may entitle the giftee to consume specific named resources. In another case, the gift may entitle the giftee to consume a certain value-amount of a specified pool of available resources. The giftee can receive and consume the thus-created gift via the electronic infrastructure.

According to one benefit, the use of an electronic infrastructure to issue and consume gifts reduces the manual operations common in traditional gifting programs. Namely, the giftor can conveniently create and electronically transmit the gift via the electronic infrastructure. The giftee can then conveniently receive and consume the gift, also via the electronic infrastructure. There is no need for a giftor to visit a store, receive a paper gift certificate, and physically transport the gift certificate to the giftee. There is likewise no need for the giftee to visit the store to redeem the gift. The convenience offered by this gifting service makes it more likely that both giftors and giftees will make use of the gifting service.

According to another benefit, the gift may induce the giftee to use an aspect of the electronic infrastructure that they have not previously utilized, or to consume resources that they might not have otherwise purchased. This establishes a powerful vehicle through which the operators of the electronic infrastructure can familiarize new users to its general services, and/or market specified resources provided by the electronic infrastructure. For example, the presence of a free gift may act as an incentive to the giftee to learn how to use some facet of the electronic infrastructure. In contrast, traditional programs may have prompted a giftee to visit a store, but provide no other user experience which integrates the giftees with the store's services.

According to another benefit, the giftor can be debited as soon as he or she creates a gift. There will typically be some delay before the giftee can use the gift. This delay, when spread over many such giftors, can provide the gifting service with float that can confer substantial financial benefit to the gifting service. In addition, the giftee rarely will have the opportunity to consume exactly the amount specified by a gift. This margin of unused value provides additional profit for the gifting service. Or the unused margin may induce the giftee to make another purchase, supplementing the gift with other forms of tender.

According to another benefit, the gifts can be presented via electronic infrastructure that the giftees regularly use, such as respective television sets and associated set-top boxes which receive media resources from an existing television system. This has the potential of making it more likely that the giftees will interact with the system. And as mentioned, the receipt of gifts can act an inducement which prompts the giftees to use some facet of the system's services with which they were previously unfamiliar—in this case, the television system's services.

Still other features and attendant benefits will be apparent to those skilled in the art upon reading the following discussion.

As to terminology, the term “gift” refers any kind of entitlement to any kind of resource that can be consumed by a giftee. The resource may pertain to a tangible good (e.g., a physical product), an intangible good (e.g., some legal privileged conferred by the gift), a service, and so forth. In preferred cases, the gift is free to the giftee, meaning that the giftee can consume the gift without incurring any costs. In other cases, the giftee may have to incur some costs to consume the gift.

In one non-limiting case, the resource pertains to electronic resource information that can be consumed by a user. The electronic resource information may be in digital form, analog form, or a combination of analog or digital forms. The electronic resource information may include, or may omit, interactive content. A specific class of electronic is resource information may pertain to media resources. The media resources can include any information that conveys audio and/or video information, such as audio resources (e.g., music, etc.), still picture resources (e.g., digital photographs, etc.), moving picture resources (e.g., audio-visual television programs, movies, etc.), computer programs (e.g., games, etc.), markup language resources (e.g., hypertext markup language resources received via a wide area packet network), and so on.

In one implementation, the electronic infrastructure that is used to implement the gifting service also distributes the resources that can be consumed using the gifts to the giftees. For instance, the electronic infrastructure can correspond to any kind of media distribution system, such as a television network, for providing media resources to consumers. In this case, the gift may entitle the giftee to consume resources that are ordinarily provided by the media distribution system. More plainly stated, the gift may entitle the giftee to consume a program or movie available via the media distribution network. However, the gifting service is not limited to this implementation. In other cases, the electronic infrastructure can accommodate the delivery of “external” resources that are not “sponsored” by the electronic infrastructure that provides the gifting services

The term “giftor” refers to any individual or entity who conveys a gift. The term “giftee” refers to any individual or entity who receive the gift. In the most common case evoked in this discussion, the giftor and the giftee have some pre-established relationship, such as familial relationship, friendship, coworker relationship, and so forth. However, in other cases, the giftor may not know the giftee. This might be the case were the giftor corresponds to a business which sends gifts to a pool of random recipients to entice the recipients to interact with the giftor business in some way.

This disclosure includes: Section A which describes an exemplary system for implementing the gifting service; Section B which describes exemplary user interface (UI) presentations for use in the system of Section A; and Section C which describes exemplary procedures for implementing the gifting service.

A. Exemplary System

FIG. 1 shows an exemplary system 100 for implementing a gifting service. Generally, any of the functions described with reference to the figures can be implemented using software, firmware (e.g., fixed logic circuitry), manual processing, or a combination of these implementations. The term “logic, “module” or “functionality” as used herein generally represents software, firmware, or a combination of software and firmware. For instance, in the case of a software implementation, the term “logic,” “module,” or “functionality” represents program code that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

A.1. Overview of System

Broadly, the system 100 defines electronic infrastructure for delivering resources to consumers, and for implementing the gifting service. The electronic infrastructure defined by the system 100 includes head-end functionality 102 which interacts with a plurality of local devices (104, 106, . . . 108). The head-end functionality 102 loosely corresponds to a collection of remote functionality used to coordinate and manage the entire electronic infrastructure. The individual devices (104, 106, . . . 108) corresponds to functionality used by consumers to receive resources from the head-end functionality 102, and also to exchange gifts among each other. In the illustrative and non-limiting example of FIG. 1, a giftor 110 uses device 104 to send a first gift to giftee 112, who is using the device 106, and to send a second gift to giftee 114, who is using the device 108. Aspects of the head-end functionality 102 and the devices (104, 106, . . . 108) will be explored in greater depth below.

The head-end functionality 102 may include one or more systems for delivering resources to recipients, and for interacting with the recipients. For instance, the head-end functionality 102 shown in FIG. 1 includes two systems, system A 116 and system B 118. The different systems (116, . . . 118) can correspond to different commercial providers of resources. These different systems (116, . . . . 118) may use different equipment to deliver their respective services, or may use, in whole or in part, shared infrastructure.

Consider the illustrative case of system A 116. This system includes a collection of components for delivering services and resources to recipients. To begin with, resource acquisition functionality 120 receives resources from one or more sources 122. The sources 122 can represent any kind of entity which produces or provides resources, such as conventional cable or satellite television providers, one or more Video-On-Demand (VOD) suppliers of resources, one or more publishing houses, one or more library sources of resources, any kind of Internet-enabled repository of resources, and so on. In one example, an entity that administers the system A 116 can enter into a contractual arrangement with the entity (or entities) that supply the resources. In another case, the entity that administers system A 116 can itself produce at least some of the resources that it provides to clients. The resource acquisition functionality 120 can receive these resources via digital network coupling, cable coupling, wireless coupling (e.g., earthbound broadcast or satellite), and so on, and then store the resources in a resource store (not shown). This resource store can represent a single database, or can represent multiple distributed databases spread over multiple respective sites.

Resource delivery functionality 124 supplies the acquired resources to the devices (104, 106, . . . 108). In the exemplary context of an Internet Protocol (IP) distribution paradigm, the resource delivery functionality 124 can deliver resources to the devices (104, 106, . . . 108) in a unicast fashion. That is, each resource can have an identifier associated therewith, such as a Uniform Resource Locator (URL). A client can request and receive a resource by specifying its identifier in an on-demand fashion. In this manner, the resource delivery functionality 124 can be simultaneously engaged in streaming different parts of the same resource to different clients. Resource delivery functionality 124 can also supply resources to the devices (104, 106, . . . 108) using conventional broadcast modes of communication, including wired (cable) and wireless (earth antenna and satellite) modes of broadcast communication.

The system A 116 can supply resources to users using different resource-packaging paradigms. In one unicast case, the system A 116 can group resources into different respective “channels,” and allow the users to select resources by specifying channel identifiers. A single channel can provide a defined chronological sequence of resources according to the traditional broadcast model of program delivery. In this case, the user can receive a desired resource by “tuning” to the channel at a prescribed time. In another case, a single channel can provide a portal that allows the user to select from a subset of resources associated with the channel. In this case, the user can receive a desired resource by “tuning” to the channel at any time and selecting one of the resources that the channel offers in an on-demand manner. In still another case, a single channel can be associated with a single resource. In this case, the user can receive this resource by “tuning” to the channel at any time and selecting this resource in an on-demand manner.

The system A 116 can interact with the devices (104, 106, . . . 108) via coupling mechanism 126. The coupling mechanism 126 can comprise any type of mechanism for transferring resources in conventional broadcast fashion, in streaming unicast fashion, in bulk fashion (e.g., as a single complete file), or in some other fashion. For instance, the coupling mechanism 126 can include any kind of network (or combination of networks), such as a TCP/IP wide area network (e.g., the Internet), an intranet, Digital Subscriber Line (DSL) network infrastructure, point-to-point coupling infrastructure, and so on. In the case where one or more digital networks are used to disseminate resources, the coupling mechanism 126 can include various hardwired and/or wireless links, routers, gateways, name servers, and so on. In the case where DSL infrastructure is used to disseminate resources, the coupling mechanism 126 can utilize the services, in part, of telephone coupling infrastructure and DSL processing functionality.

The system 116 A can include system management functionality 128. The system management functionality 128 serves the role of governing the operation of the system A 116. To perform this role, it can perform a number of tasks. For instance, the system management functionality 128 can include logic which enables system A 116 to interact with other systems, such as system B 118. In addition, the system management functionality 128 can include logic which administers certain subscriber registration operations. In addition, the system management functionality 128 can include logic which administers various accounting operations, such as maintaining billing records for resources consumed by users. This is merely an illustrative and non-limiting list of tasks that the system management functionality 128 can perform.

The system management functionality 128 also includes gift processing (GP) functionality 130 which administers certain aspects of the gifting service. Namely, the GP functionality 130 interacts with a giftor to create a gift. The GP functionality 130 also coordinates the transfer of the gift to the giftee. The GP functionality 130 also interacts with the giftee, enabling the giftee to receive the gift and to consume resources using the gift.

Although not shown, system B 118 can include the same, or similar, functionality to that shown for system A 116.

To facilitate gift exchange operations, the system 100 can also include inter-system management functionality 132. The inter-system management functionality 132 can provide certain global resources that can be accessed by any system that participates in gifting. Additionally, the inter-system management functionality 132 can coordinate the gifting between disparate systems 132 that may employ different architectures, protocols, and so forth.

More specifically, system A 116 may have a first pool of users associated therewith, including giftor 110 and giftee A 112. System B 118 may have a second pool of users associated therewith, including giftee B 114. Consider the illustrative case where giftor 110 sends a gift to giftee A 112. This transaction takes place between two participants of system A 116. In this case, the GP functionality 130 may not need to access the inter-system management functionality 132 to coordinate the gifting (although, in other cases, as will be described below, intra-system gifting can optionally use the services of the inter-system functionality 132). Consider, in contrast, the case where giftor 110 sends a gift to giftee B 114. This transaction bridges two different systems (116, 118). In this case, the GP functionality 130 needs to interact with system B 118 to coordinate the gifting, and therefore can use the services of the inter-system management functionality 132.

FIG. 3, to be discussed below in turn, provides additional information regarding the exemplary composition of system A 116 and the inter-system management functionality 132.

The device (110, 112, 114) can include respective processing mechanisms (134, 136, . . . 138) and associated presentation units (140, 142, . . . 144). In general, a processing mechanism (134, 136, . . . 138) can correspond to any equipment used to process resources for consumption at a presentation unit. An exemplary processing mechanism (134, 136, . . . 138) can correspond to any one of a set-top box, software and/or hardware functionality integrated into the associated presentation unit (140, 142, . . . 144) itself, a general purpose or special purpose computer device, and so forth. An exemplary presentation unit (140, 142, . . . 144) can correspond to any one of a television set, an audio presentation unit (e.g., a stereo system), a computer monitor, and so forth.

In operation, again consider the case where the giftor 110 uses the client processing mechanism 134 to create a gift 146, intended for receipt by giftee A 112. As mentioned above, giftor 110 and giftee A 112 subscribe to (or otherwise have access to) the same system A 116. The giftor 110 can create a gift using a series of user interface (UI) presentations devoted to this task, presented on the presentation unit 140 by the client processing mechanism 134. Section B sets forth exemplary UI presentations for performing this operation. The giftor 110 can create the gift by first of all specifying the recipient of the gift 146—namely, giftee A 112. The giftor 110 can identify the giftee A 112 by typing identification information associated with the giftee A 112, such as the telephone number of the giftee A 112. The giftor 110 also specifies the nature of the resources that can be purchased with the gift 146. For instance, in one case, the giftor 110 can specify that the gift 146 can be redeemed for specific resources, for instance, by expressly specifying the identity of the resources. In the context of a media distribution infrastructure, this kind of gift 146 can allow the giftor 110 to specify the names of specific movies that can be purchased using the gift 146. Or the giftor 110 can define a gift 146 which specifies a monetary amount. The giftee 146 remains free to use the gift 146 to purchase any one of a general class of resources (such as any movie available through the head-end functionality 102), providing that the movie price does not exceed the value of the gift 146). The GP functionality 130 then coordinates the transfer of the gift 146 from the client processing mechanism 134 to the client processing mechanism 136. In one case, the GP functionality 130 can perform this task using only its local services system A (because both the giftor 110 and the giftee A 112 belong to the same system A 116). In another case, the GP functionality 130 can rely on logic provided by the inter-system management functionality 132 to perform the gift transfer. In any event, upon receipt, the client processing mechanism 136 alerts the giftee A 112 to the receipt of the gift 146, such as by displaying an alert on the presentation unit 142 associated with device 106. The client processing mechanism 136 can then provide a series of additional UI presentations to facilitate the giftee 112's consumption of the gift 146. Again, Section B sets forth, in greater detail, exemplary UI presentations that can perform the above-described operations.

As described above, the giftor 110 can also send a gift 148 to the giftee B 114 who subscribes to a different system B 118. This operation parallels the sequence of steps described above. However, in this case, the GP functionality 130 can rely more heavily on the use of the inter-system management functionality 132 to coordinate the transfer of the gift 148 from client processing mechanism 134 to the client processing mechanism 138.

A.2. Exemplary Device for Creating and Receiving Gifts

FIG. 2 provides further details regarding one implementation the representative device 104, comprising the processing mechanism 134 coupled to the associated presentation unit 140. As mentioned above, the processing mechanism 134 can be implemented as a set-top box or functionality integrated with the presentation unit 134 itself. Or the processing mechanisms 134 can be implemented as any other application-specific unit (such as a game console, e.g., the Xbox™ game console produced by Microsoft Corporation of Redmond, Wash.). Or the processing mechanism 134 can be implemented by a general purpose computer device, and so forth. In any case, the processing mechanism 134 can include one or more processors 202 for executing machine readable code, ROM memory 204 and RAM memory 206 for storing machine readable code and other data, and a local store 208 for storing any data of a more permanent nature than RAM 206. The processing mechanism 134 can also include one or more coupling interface mechanisms 210 for interacting with the head-end functionality 102 via one or more communication paths (212, 214), an I/O interface 216 for interacting with one or more user input devices, an audio-visual (A/V) interface 218 for interacting with the presentation unit 140, and various other optional modules 220. One or more busses 222 couple all of the above-identified components together and coordinate their cooperation.

The logic functionality used to implement the gifting service can be spread throughout the system 100 (of FIG. 1). For instance, as described above, the GP functionality 130 in the head-end functionality 102 can provide logic that implements certain aspects of the gifting service. The processing mechanism 134 can also include logic that implements aspects of the gifting service. For instance, the processing mechanism 134 can include logic that provides various UI displays that allow the giftor 110 to generate and transmit a gift, and that allow a giftee (112, 114) to receive and consume a gift sent by the giftor 110. In this implementation, during execution, RAM 206 can store processor-readable code 224 that implements aspects of the gifting service when this code is executed by the processor(s) 202. Alternatively, the processing mechanism 134 can implement aspects of the gifting service in whole or in part, using fixed (e.g., non-programmable) logic circuitry. Generally, the distribution of logic between head-end functionality 102 and client processing mechanism 134 can be varied to suit the requirements of different applications within different technical environments; in one case, for instance, the head-end functionality 102 can house all of the code used to implement the gifting service.

The presentation unit 140 is shown in FIG. 2 as a television set 226, although the presentation unit 140 can also be implemented as a stereo output system, or some other kind of media output device. In other cases, the presentation unit 140 can represent a combination of different output devices working in cooperation to present media resources. The processing mechanism 134 can be configured to present one or more UI presentations 228 to assist a user in interacting with the gifting services. These interface presentations 228 can be presented as overlay screens that overlay a television program or movie that the user happens to be watching while interacting with the gifting service.

A remote controller 230 serves as one possible input device for interacting with the client processing mechanism 134. A user can use the remote controller 230 to select resources, to pause resources, to resume previously paused resources, and for performing other tasks. A user can also use the remote controller 230 to interact with the gifting service, such as by creating and consuming gifts. As generally shown in FIG. 1, the remote controller 230 includes a collection of keys 232, a control module 234 for processing the user's actuation of the keys 232 to provide user instructions, and an interface module 236 for transmitting the user's instructions to the processing mechanism 134 via wireless communication (e.g., infrared communication).

A number of other input devices 238 can be used to interact with the services provided by the head-end functionality 102, in addition to, or as substitute for, the remote controller 230. For example, the other input devices 238 can represent a keyboard, a mouse-type input device, a joystick, and so on. Alternatively, or in addition, a user can use a separate computer device (such as a general purpose computer, a laptop computer, etc.) to enter commands to the head-end functionality 102 and to receive feedback from the head-end functionality 102, to thereby control the presentation of programs by the presentation unit 134.

FIG. 2 shows that there is a two-way exchange between the client processing mechanism 134 and the head-end functionality 102, as defined by paths 212 and 214. Namely, path 212 can be used to receive resources from the head-end functionality 102, such as television programs, movies, music, games, and so forth. Paths 214 are used to transmit and receive other data to and from the head-end functionality 102. For instance, these paths 214 can allow a giftor to transmit a gift to a giftee. and can allow the giftee to receive the gift. In terms of physical implementation, the paths (212, 214) can correspond to separate channels. For example, path 212 can correspond to a cable link, IP link, wireless link, and so forth, while paths 126 may correspond to a separate dedicated line (such as a telephone) line for transmitting and receiving gift-related control information. In other implementations, path 212 and path 214 can correspond to the same channel. For instance, in a DSL service, the same physical DSL functionality can be used to receive resources from the head-end functionality 102 and to perform gifting operations requiring a two-way exchange of information between the client processing mechanism 134 and the head-end functionality 102. Still other implementations are possible, encompassing any type and combination of communication channels.

A.3. Head-End Functionality

FIG. 3 provides further details regarding one implementation of the head-end functionality 102. As described in Subsection A.1, the head-end functionality 102 can include a plurality of systems, including representative system A 116 and system B 118. System A 116 and system B 118 can represent infrastructure managed by two different commercial entities and having respective groups of users who interact with the respective systems (116, 118). The systems (116, 118) may include separate components or may share certain processing resoruces.

As described in connection with FIG. 1, system A 116 includes system management functionality 128, which coordinates the operation of system A 116. System B includes system management functionality 302 which coordinates the operation of system B 118. The exemplary components within the system management functionality 128 of system A 116 are shown in FIG. 2.

Namely, the system management functionality 128 can include inter-system interaction functionality 304. The purpose of this functionality 304 is to interact with the inter-system management functionality 132. For example, the inter-system interaction functionality 304 allows system A 116 to communicate with system B 118 via the inter-system management functionality 132.

The system management functionality 128 also can include local billing functionality 306. The purpose of the local billing functionality 306 is to track of the current pool of users who subscribe to system A, and to maintain records regarding purchases, billings sent out to subscribers, subscriber payments, and so forth.

The system management functionality 128 also can include one or more stores 308 for storing information.

The system management functionality 128 also includes the gift processing (GP) functionality 130 introduced in the context of FIG. 1. The GP functionality 130 coordinates, in cooperation with a client processing mechanism, the creation and transmission of a gift to a giftee. The GP functionality 130 also coordinates the receipt and consumption of that gift by the giftee. In performing its tasks, the GP functionality 130 can maintain billing records associated with the issuance and redemption of gifts. In so doing, the GP functionality 130 can interact with the local billing functionality 306 and a gift-related database 310 provided in the system store 308.

Further, the GP processing functionality 130 can rely on giftee identification functionality 312 in creating a gift. The purpose of the giftee identification functionality 312 is to identify a giftee on the basis of identification information provided by the giftor. In one implementation, the giftee identification functionality 312 is configured to identify a giftee on the basis of the telephone number of the giftee, input to the GP functionality 130 by the giftor. In another case, the identification functionality 312 is configured to identify the giftee on the basis of the giftee's name, address, any identifying ID number, and so forth. In the case in which a telephone number is used, the identification functionality 312 can perform a lookup operation which maps the telephone number to information that identifies the address of the device being used by the giftee, or any other enabling address information that allows the GP functionality 130 to transfer the gift to the giftee. One way that the identification functionality 312 can perform this lookup is by accessing a system-local mapping database 314. This mapping database 314 can correlate the input telephone number with various salient information regarding giftees, such as their residential address, the address of their device, and so forth. Indeed, in one implementation, the system 116 may already store information regarding the telephone numbers of its subscribers in order to deliver resources to the subscribers in the normal course of operation of the system A 116. This is particularly the case with the use of DSL-type delivery of resources, which can couple to client processing mechanisms via telephone links. The fact that the system A 116 may already store telephone numbers of its subscribers may allow the system 116 to be more easily adapted to implement the new gifting service. Alternatively, or in addition, the identification functionality 312 can map the telephone number to salient information regarding the giftees by accessing a global inter-system database 316. FIG. 3 shows the exemplary case where the inter-system management functionality 132 implements this database 316. This database 316 can provide a general repository of information regarding giftees. In one case, the general repository 316 may be specially developed for use with the gifting service; in another case, the general repository 316 may represent a publicly accessible lookup service, which stores information regarding a large pool of individuals, only a subset of which may subscribe to the electronic infrastructure which allows them to create and receive gifts in the manner described herein.

FIG. 3 shows optional other components of the inter-system management functionality 132. In general, the inter-system management functionality 132 may be maintained by a third party, such as a central clearinghouse-type entity. The cooperating systems (116, . . . 118) may contractually agree to let this third part handle certain inter-system aspects of gifting transactions. Alternatively, the plural systems (116, . . . 118) may together provide and manage the inter-system management functionality 132. Or potentially only a subset of cooperating systems (116, . . . 118) may maintain this functionality 132.

The inter-system management functionality 132 can include an inter-system billing functionality 318. This component 318 may come into play where separate systems may, by contractual agreement, entrust the inter-system billing functionality 318 to make accounting for billing activities associated with the transmission of the gifts between systems. For instance, a system may charge non-subscribing giftors a prescribed fee to send a gift to one of its subscribing users. In this context, the inter-system billing functionality 318 can make accounting of such transactions and the assessed associated surcharges. This is merely one example of how multiple systems may, through prior agreement, entrust certain inter-system processing tasks to the inter-system management functionality 132. Other aspects of gift transactions which may take place entirely within a particular system can be entrusted to the local billing functionality 306. Generally, to ensure coordination in billing, the inter-system billing functionality 318 can be configured to interact with the local billing functionalities (e.g., billing functionality 306 of system A 116) of individual systems.

The inter-system management functionality 132 also can provide inter-system coordination functionality 320 which allows the inter-system management functionality 132 to govern the exchange between different systems. The physical and logical mechanism for coupling the systems (116, . . . 118) together is provided by an inter-system coupling mechanism 322. This coupling mechanism 322 may correspond to propriety lines, maintained by the inter-system management functionality 132, coupling systems (116, . . . 118) together. Or the inter-system management functionality 132 can rely on public coupling mechanisms, such as the Internet (with appropriate security provisions) to exchange information between systems (116, . . . 118). These implementations are meant to be illustrative rather than limiting; other technical environments may adopt different strategies for coupling diverse systems together.

In one particular case, system A 116 may provide first UI functionality for issuing and consuming gifts, while system B 118 can provide second UI functionality for issuing and consuming gifts. The UI functionality between the two systems (116, 118) can differ in terms of content collected, as well as style of presentation. The system coordination functionality 320 can come into play in this circumstance by performing translation between different formats. Alternatively, the multiple systems (116, . . . 118) may agree upon common features of the gift processing services, or at least a certain minimal set of common features (such as an exemplary insistence that giftees be identified by their telephone numbers). Specific schemas and standard protocols can be developed to standardize cooperation between disparate systems.

In terms of physical embodiment, any of the functionality implemented by the head-end functionality 102 can be provided by one or more servers (e.g., a server farm). A computer server refers to a computer device that is configured to provide a service to a requesting device. Although not shown, a typical computer server can include one or more processors (e.g., CPUs), random access memory (RAM), read only memory (ROM), various media storage drives, various network interface functionality, various input and output devices, various internal coupling mechanisms (such as buses), and so on. The head-end functionality 102 can dedicate different servers to handling different functions provided by the head-end functionality 102, such as administrative tasks, receiving/recording tasks, resource dissemination tasks, and so on. The head-end functionality 102 can alternatively, or in addition, allocate plural servers to performing the same tasks using various load balancing algorithms to meet client demand for services. The head-end functionality 102 can be implemented at a single site or distributed over plural sites.

Any of the data stores (e.g., store 308) provided by the head-end functionality 102 can be implemented using any kind of magnetic storage media, optical storage media, solid state type storage media, or other kind of storage media. Any kind of database management logic can be used to interact with the data stores (e.g., 308). The data stores can be implemented at a single site or distributed over plural sites.

While the implementations featured above rely predominantly on the head-end functionality 102 to coordinate the gifting service, other implementations are possible. For instance, the gifting service can implement certain aspects of the gifting transactions by conducting peer-to-peer (P2P) exchange between participants, which can be set up by the head-end functionality 102.

B. Exemplary User Interface Functionality

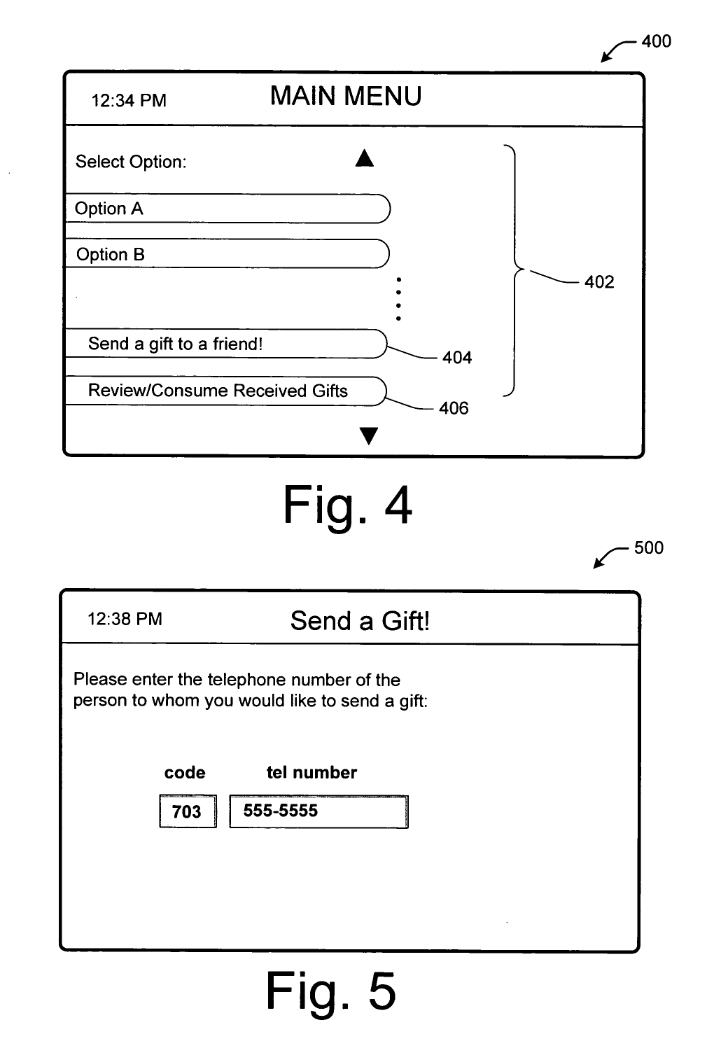

FIGS. 4-7 show various user interface (UI) presentations that can be provided to the giftor and giftee in the course of performing a gifting transaction. In one case, these UI presentations constitute picture-in-pictures (PIPs) that can be overlaid on top of a principal picture that is being displayed by the presentation unit (e.g., unit 140) associated with the client processing mechanism (e.g., mechanism 134, e.g., which may comprise a set-top box). In another case, the UI presentations can occupy an entire display surface of the presentation unit. In any case, each of the processing mechanisms (134, 146, . . . 138) can include code specifically configured to display the UI presentations of the nature to be described below. Generally, the UI presentations are exemplary and are presented for illustration purposes only; other applications of the gifting service described herein can use UI presentations that differ in content, style, sequence of presentation, and so forth.

To begin with, FIG. 4 shows an exemplary UI presentation 400 that a giftor can use to initiate a gifting transaction, or to review previously received gifts. The UI presentation 400 corresponds a main menu having a number of options 402 from which the giftor may select. One option 404 invokes the gifting service, whereby the giftor can issue a gift to a designated recipient. Another menu option 406 might allow a giftee to examine and/or consume one or more previously received gifts.

In one case, activating the gifting option 404 invokes a series of UI presentations devoted to the gifting service. FIG. 5 shows a UI presentation 500 that can be presented first (although it need not be presented first). This UI presentation 500 prompts the giftor to identify the giftee. This screen particularly asks the giftor to identify the giftee by identifying the telephone number of the giftee. This identification data may be beneficial, as the enabling system may retain this information already, or, in any event, it is generally possible to consult general databases to map a telephone number to other salient information regarding the individual. The giftor can enter information into UI presentation 500 in various ways, such as using the remote control module 230 of FIG. 2, using a keyboard, and so forth.

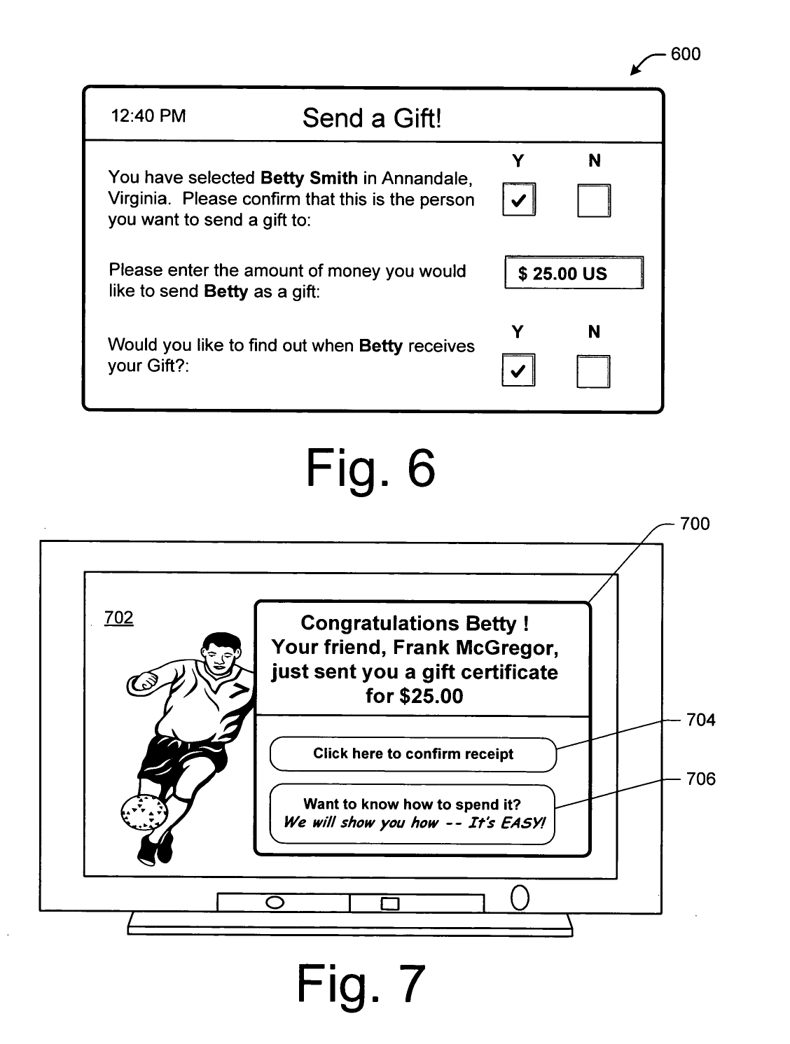

Upon entering the telephone number, the gifting service can prompt the generation and display of the UI interface presentation 600 shown in FIG. 6. This UI interface presentation 600 can include an initial field of information which identifies the name, or other identifying data, associated with the telephone number input by the giftor via UI presentation 500. The gifting service can determine this information via mapping information provided by the local giftee information store 314 and/or the inter-system giftee store 316. This confirmation is important in case the giftor inadvertently entered the incorrect telephone number. Also, where two individuals may be associated with a particular telephone number, the gifting service can display both (not shown in FIG. 6), and allow the giftor to select between the two. These provisions reduce the risk of a giftor sending a gift to the incorrect recipient. The giftor can indicate that the displayed information is correct by entering a check mark in the YES box, or through some like UI control mechanism.

The second field in the UI presentation 600 prompts the giftor to define the nature of what is being conferred via the gift. In the case shown in FIG. 6, the system 100 is set up to issue gifts for value amounts that can be specified by the giftor. Here the giftor has entered a value amount of twenty five dollars. This means that the gift enables the giftee to spend up to twenty dollars in consuming resources of a particular nature, such as movies. Alternatively, the gift can be designed to target specific resources. For instance, the giftor may have enjoyed a particular movie or piece of music and wishes to issue a gift to a friend which confers this specific resource. Although not shown, various UI techniques can be used to allow the giftor to select specific resources, such as by allowing the giftor to scan through and pick resource items from a database, allowing the giftor to enter free-form text information that identifies the resource items, and so forth.

Although not shown, the gift may optionally include a number of other features that can be user-defined. For example, a UI presentation (not shown) can be provided that allows the giftor to enter a customized message to the giftee, such as or “Bob, here is a gift certificate that allows you to watch the Eagles reunion concert; tell me what you think about it,” or “Johnny, here is 35 dollars; please spend it only on non-violent movies,” and so on.

Speaking of prohibitions, the gifting service can include functionality which allows a giftor to limit how the giftee can spend a gift. This might be particularly appropriate for gifts to children. For instance, it may be desirable to allow a child to consume certain pay-for-view resources that air during the day, but not at night, or particular resources that have either a G or PG rating. One or more UI presentations can be provided that allow a giftor to enter any such restrictions. These restrictions may define various flags associated with the gift. When the giftee attempts to the consume resources based on the gift, the GP functionality 130 will read the flags to determine whether the selected resource can be consumed using the gift.

As another special feature, the giftor might be able to convey bookmarks which point to particular points of interest within a resource that is specifically earmarked as a gift. The giftee can advance to those parts (e.g., scenes) of the gifted resource by activating the bookmarks.

As another special feature, the giftor can set up a series of gifts that will be delivered over a defined time span. For instance, the giftor can set up the gift such that the giftor will receive a gift having a prescribed monetary amount each month for a year, or a specifically identified movie each month (which may be specifically chosen by the giftor or automatically selected by the gifting service).

Still other special features can be integrated into the gifting service to suit different business and technical environments.

A final field in the UI presentation 600 allows the giftor to specify whether he or she wishes to receive a confirmation that the giftee has received the gift. The gifting service can generate such a confirmation when the gift message is successfully transmitted to the processing mechanism associated with the giftee. Alternatively, the gifting service may generate a confirmation only when the giftee expressly takes some action regarding the message which signals its receipt.

FIG. 7 shows a UI presentation 700 that can be displayed at the giftee's presentation unit upon receipt of a gift sent by a giftor. In one case, the UI presentation 700 can be overlaid on top of whatever program 702 that the giftee happens to be watching at the time (in this case, a televised soccer game). The UI presentation 700 thus serves as a pleasant alert. The alert may specifically inform the giftee that he or she has received a gift, and may optional specify who sent it and the cash value of the gift (or other benefits conferred by the gift). Alternatively, such alerts can be sent to the user through a less intrusive route, such as by logging an indication of the receipt of the gift in a service akin to an Email inbox. The giftee can then periodically visit the inbox and determine whether it contains any new messages.

The UI presentation 700 can optionally give the user the option, via input field 704, to confirm receipt of the gift. The UI presentation 700 can also provide a portal, via input field 706, which allows the giftee to access various information regarding the gift, such as instructions on how to use it. In one case, the UI presentation 700 may automatically be removed after a prescribed amount of time, such as one minute. The giftee can also take express steps to remove the UI presentation 702 to continue watching the primary program 702 unobstructed by the overlaid UI presentation 702.

Although not shown, the gifting service can also allow the giftee, at any time, to review previously received gifts. Such a UI presentation can be activated via the menu option 406 shown in FIG. 4. Such a UI presentation can provide a summary of received gifts, including salient information regarding the gifts, such as who sent each gift, the amount of money remaining for each gift, and so forth. When a gift has been completely consumed (e.g., by exhausting its funds), the UI presentation can be optionally updated to remove the corresponding gift entry. The local billing functionality 306, possibly in cooperation with the inter-system billing functionality 318, can perform the task of monitoring the remaining funds associated with gifts.

C. Exemplary Method of Operation

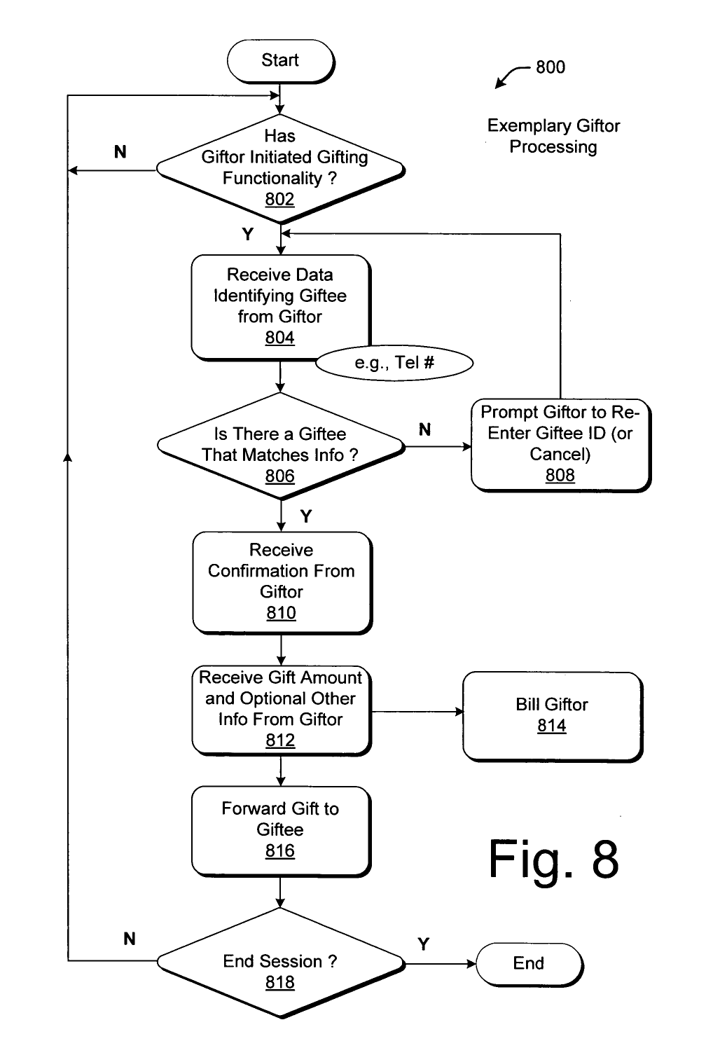

FIGS. 8-10 describe the operation of the system 100 of FIG. 1 in flow chart form. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure.

To begin with, FIG. 8 shows a procedure 800 that allows a giftor to generate and send a gift to a giftee. In step 802, the gifting service determines whether the giftor has initiated the gifting service, such as by invoking the menu option 404 shown in FIG. 4.

In step 804, the gifting service receives data identifying the giftee from the giftor. As shown in FIG. 5, this identifying data may correspond to the telephone number of the giftee. Other identifying data can be used, such as the address of the giftee, an ID number assigned the giftee, the name of the giftee, and so forth.

In step 806, the gifting service determines whether the entered IUD information can be successfully mapped to a person that the system 100 is able to send a gift to. For instance, the inter-system management functionality 132 may maintain information regarding a family of systems, and their associated membership, thus identifying individuals who can participate in the gifting program. If the telephone number maps to any member in one of these systems, then the gifting service answers step 806 in the affirmative. If the ID information fails to map to a valid recipient, then step 808 comes into play by prompting the giftor to re-enter valid giftee ID information, or entirely cancel the gifting operation.

In step 810, if there is indeed a person or plural persons that can viably receive the gift, then the gifting service can identify these individual (or individuals) and ask the giftor to confirm that these individuals should receive the gift. In the case where a single telephone number happens to map into plural recipients, the gifting service can optionally give the giftor an opportunity to pick one of the individuals—such as a wife, rather than her husband, associated with the same telephone number.

In step 812, the gifting service allows the user to define the nature of the gift. In the case where the gift targets specific resources, the giftor can enter identifying information that specifies those resources. In the case that the gift targets only a specific monetary amount, the giftor can enter that amount. In any event, in step 814, the gifting service debits the giftor's account. Debiting the giftor's account at this time is advantageous because there will be a lapse of time before the giftee consumes the gift. Until that time, the debited money is float. Spread over many thousands of subscribers, such a float can provide a significant financial boon to the providers of the gifting service.

In step 816, the gifting service forwards the thus-defined gift to the giftee. The head-end functionality 102 can perform this role. For intra-system transfers, a single system can potentially perform this transfer without the services of the inter-system management functionality 132. In inter-system transfers, the head-end functionality will likely rely on the inter-system management functionality 132.

In step 818, the gifting service determines whether the enabling system continues to operate, or has shut down, at least with respect to the giftor identified in FIG. 8.

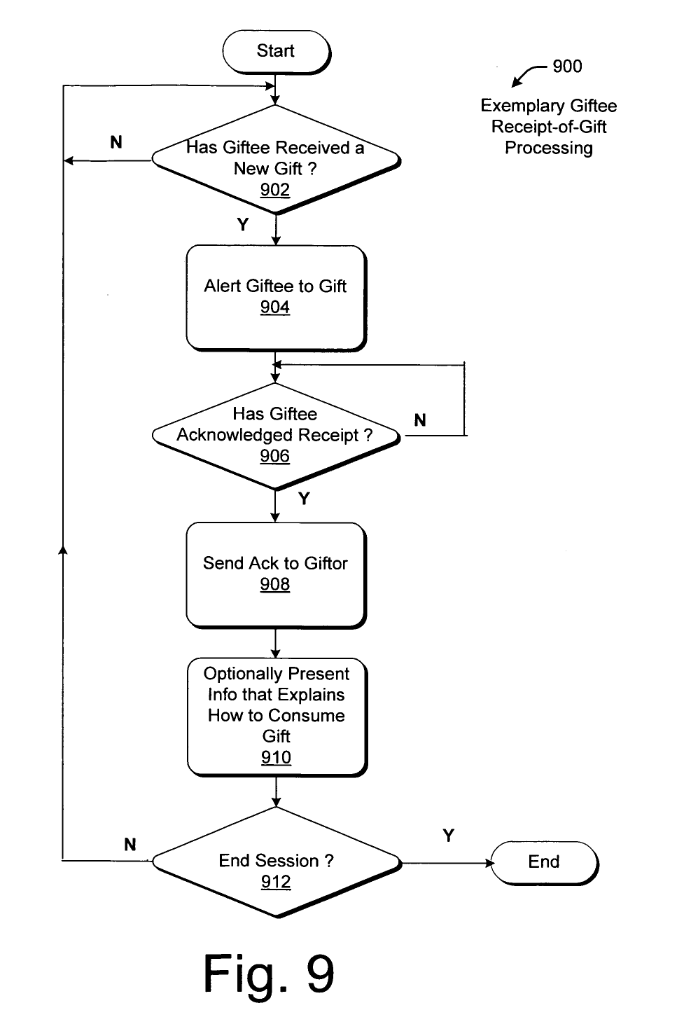

FIG. 9 shows a procedure 900 that allows a giftee to receive a gift. In step 902, the gifting service determines whether the giftee has received the gift. For instance, the processing mechanism used by the giftee may set a flag that internally alerts the processing mechanism when a new gift message has been received.

In step 904, when a gift has been received, the gifting service alerts the giftee to this event. FIG. 7 shows one such exemplary and non-limiting UI presentation 700 that could be used to perform this alerting task, among many other kinds of presentations.

In step 906, the gifting service determines whether the giftee has acknowledged receipt of the gift. One technique that enables a giftee to acknowledge receipt is via the acknowledgment input field 704 shown in FIG. 7. Or the gifting service may automatically generate such an acknowledgment when the giftee takes any action with respect to the gift, including simply deleting it. The giftee is also afforded the opportunity to move received gifts to a specific gift-related folder, functioning as an electronic purse containing gifts. The giftee may examine such a purse at any time, and consume gifts from the purse at any time (e.g., by activating the menu option 406 shown in FIG. 4).

In step 908, providing that the giftee has acknowledged receipt, then the gifting service sends an acknowledgement back to the giftor, that is, if the giftor has registered to receive such as notification.

In step 910, the gifting service can optionally provide information that explains to the giftee how to use the gift. Input field 706 is one such way to invoke this operation. The gifting service may respond by presenting information regarding the kinds of resources that can be consumed using the gifts, and so forth. In a particular case, the gifting service may provide a short tutorial regarding how to use the general services provided by the media distribution infrastructure that provides the resources. This provides a good opportunity to familiarize new users with the media distribution infrastructure, making these users more likely to use this service in the future, even in the absence of a gift. This is a notable benefit of the gifting service described herein. Prior manual gifting programs do not provide effective techniques for integrating a giftee with the business which sponsors the gifts.

In step 912, the gifting service determines whether the enabling system continues to operate, or has shut down, at least with respect to the giftee identified in FIG. 9.

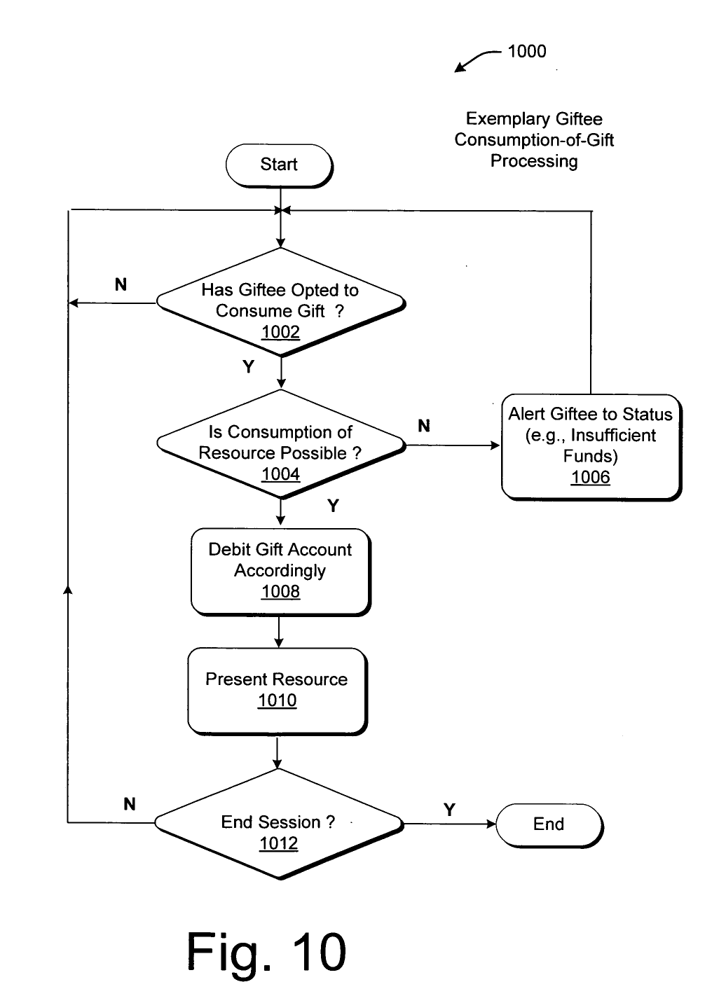

Finally, FIG. 10 a procedure 1000 which allows a giftee to consume a gift. In step 1002, the gifting service determines whether giftee has opted to consume a received gift, at least in part.

If so, in step 1004, the gifting service determines whether a purchase that the giftee has in mind is possible. The gifting service will determine that the purchase is not possible if the amount of the resource being purchased exceeds the amount of value remaining on a gift. In this event, step 1006 comes into play by alerting the giftee to the insufficient funds, or other problem. The giftee can then take appropriate action, such as by abandoning the purchase or by supplementing the gift with other forms of legal tender (e.g., by charging part of the purchase to the giftee's credit card account). A gift may be proscribed for other reasons, such as when the giftee attempts to purchase a resource that has been earmarked as prohibited by the giftor.

In step 1008, where a purchase is possible, the gifting service debits the gift amount associated with the gift. For example, if the gift originally specified an amount of twenty five dollars, and the giftee purchased a movie for four dollars, then the gifting service would perform appropriate accounting to indicate that the gift now has twenty one dollars remaining. The local billing functionality 306, in potential cooperation with the inter-system billing functionality 318, can perform this function. When the value of the gift reaches zero, the gifting service can automatically delete it from the gift-related records locations that can be accessed by the giftee.

The accounting framework used to credit and debit accounts may have various potential benefits to the gifting service. In one scenario, the giftee may be unable to consume the exact amount of the gift. This unused margin can constitute profit to the gifting service. The gifting service can alert the giftee that it will automatically delete gifts having very low values if they remain unused for a prescribed period of time, such as six months or a year. In another case, the giftee may be unwilling to forgo even a small amount of value available on a gift, prompting the giftee to supplement the gift with other forms of legal tender to make a purchase. This is a purchase that the giftee might not have otherwise made, but for the inducement of the gift, thus financially benefiting the system which provides the resources.

In step 1010, the gifting service, in cooperation with the resource delivery infrastructure itself, provides the purchased resource. In one case, the resource delivery infrastructure (e.g., functionality 120, 122, 124 of FIG. 1) can provide resources from its usual stock of resources (122) provided by the system 100; in other cases, the resource delivery infrastructure can acquire external resources to satisfy certain requests made by the giftee.

In step 1012, the gifting service determines whether the enabling system continues to operate, or has shut down, at least with respect to the giftee identified in FIG. 9.

The above discussion has been framed in the context of a single individual sending another single individual a gift, where these individuals typically have a pre-established relationship. They might be friends or relatives or classmates, for example. In other more commercial applications, the giftor may represent something equivalent to a bulk mailer. The giftor in this case might send out potentially hundreds or thousands of gifts to individuals that are specifically culled from a database, that may, for instance, meet some marketing criteria. For instance, the giftor may want to entice individuals who are know to have purchased an item A to purchase an item B which complements item A in some way, or which is a competitive product of the same nature as item A. Or the giftor can send out many gifts to entirely random recipients. Where telephone numbers are used to identify recipients, the giftor can randomly select telephone numbers, or perhaps randomly select telephone numbers within a certain area code, and so forth. In general, this provision provides powerful up-sell and cross-sell opportunities to these commercial giftors. In one implementation, the giftees can receive the gifts via electronic distribution infrastructure that they already regularly use, such as their television sets. This may improve the giftee's willingness to use these gifts. The fact that the recipients have received something of value for free is also a powerful inducement to use the gifts.

In closing, a number of examples have been presented in this disclosure in the alternative (e.g., case A or case B). In addition, this disclosure encompasses those cases which combine alternatives in a single implementation (e.g., case A and case B), even though this disclosure may not expressly mention these conjunctive cases in every instance.

More generally, although the invention has been described in the context of specific to structural features and/or methodological acts, it is to be understood that the invention defined in the appended claims is not necessarily limited to the specific features or acts described. Rather, the specific features and acts have been presented as exemplary strategies for implementing the claimed invention.

What is claimed is:

1. A method for gifting resources via an electronic infrastructure, comprising:
receiving instructions from a giftor to create a gift via the electronic infrastructure, wherein one instruction identifies a recipient of the gift, defining a giftee;
creating the gift based on the giftor's instructions;
transmitting the gift to the giftee via the electronic infrastructure; and
providing a resource to the giftee, via the electronic infrastructure, in response to the giftee using the gift.

2. The method of claim 1, wherein the electronic infrastructure defines a system for distributing media resources to the giftor and giftee.

3. The method of claim 2, wherein the resource provided to the giftee is a media resource.

4. The method of claim 1, wherein the electronic infrastructure includes plural systems for distributing resources coupled together in cooperative engagement.

5. The method of claim 4, wherein the giftor and giftee belong to the same system.

6. The method of claim 4, wherein the giftor and the giftee belong to different systems, and wherein the transmitting comprises transmitting the gift from the giftor's system to the giftee's system.

7. The method of claim 1, wherein the instruction that identifies the giftee identifies a telephone number of the giftee.

8. The method of claim 8, further including identifying the giftee based on the telephone number by accessing a database which maps telephone numbers to other giftee identification data.

9. The method of claim 1, wherein another instruction identifies a benefit conferred by the gift.

10. The method of claim 9, wherein the benefit conferred is a monetary value that can be applied to purchase the resource.

11. The method of claim 9, wherein the benefit conferred is an entitlement to purchase a named resource.

12. The method of claim 1, further including debiting an account associated with the giftor after the gift is created.

13. The method of claim 1, further including debiting an amount from the gift when the giftee consumes the resource.

14. The method of claim 1, further including, following the transmitting of the gift, alerting the giftee to the presence of the gift.

15. The method of claim 14, wherein the alerting comprises sending the giftee a message via an audio-visual presentation unit operated by the giftee.

16. One or more machine readable media including machine readable instructions for implementing each of the receiving, creating, transmitting, and providing of claim 1.

17. A method for gifting resources via a resource distribution electronic infrastructure, comprising:
receiving a gift created by a giftor via the resource distribution electronic infrastructure, wherein the gift specifies identification data that identifies a giftee who will receive the gift;
transmitting the gift to the giftee via the resource distribution electronic infrastructure based on the identification data; and
providing a media resource to the giftee, via the resource distribution electronic infrastructure, in response to the giftee using the gift.

18. The method of claim 17, wherein the identification data comprises a telephone number assigned to the giftee.

19. The method of claim 17, wherein the resource distribution electronic infrastructure is an infrastructure for distributing media resources.

20. One or more machine readable media including machine readable instructions for implementing each of the receiving, identifying, transmitting and providing of claim 17.

21. A system for gifting resources, comprising:
a giftor processing mechanism and associated giftor presentation unit for receiving instructions from a giftor to create a gift via an electronic infrastructure, wherein one instruction identifies a giftee recipient of the gift;
a giftee processing mechanism and associated giftee presentation unit for receiving the gift from the giftor; and
head-end infrastructure for coordinating the exhange of the gift between the giftee and the giftor using the electronic infrastructure.

22. The system of claim 21, wherein the electronic infrastructure defines a system for distributing media resources to the giftor and giftee.

23. The system of claim 22, wherein the resource provided to the giftee is a media resource.

24. The system of claim 21, wherein the electronic infrastructure includes plural systems for distributing resources coupled together in cooperative engagement.

25. The system of claim 24, wherein the head-end functionality includes inter-system management functionality for coupling the plural systems together.

26. Head-end infrastructure for gifting resources via a resource distribution electronic infrastructure, comprising:
logic configured to receive a gift created by a giftor via the resource distribution electronic infrastructure, wherein the gift specifies identification data that identifies a giftee who will receive the gift;
logic configured to transmit the gift to the giftee via the resource distribution electronic infrastructure based on the identification data; and
logic configured to provide a media resource to the giftee, via the resource distribution electronic infrastructure, in response to the giftee using the gift.

27. The head-end infrastructure of claim 26, wherein the identification data comprises a telephone number assigned to the giftee.

28. The head-end infrastructure of claim 26, wherein the resource distribution electronic infrastructure is an infrastructure for distributing media resources.
